(19) United States
(12) Patent Application Publication
(10) Pub. No.: US 2010/0121750 A1
(43) Pub. Date: May 13, 2010

(54) Funding Roadmap

(75) Inventor: Reginald Wayne Spivey, Los Angeles, CA (US)

Correspondence Address: Ruth E. Hedges, CEO;Unismart Capital Software, Inc., 1973 Thunderidge Circle, Henderson, NV, 89012, US

(73) Assignee: Unismart Capital Software, Inc., Henderson, CA (US)

(21) Appl. No.: 12/614,425

(22) Filed: Dec. 8, 2009

Related U.S. Application Data
(60) Provisional application No. 61/113,287, filed on Nov. 11, 2008.

(51) Int. Cl. G06Q 10/00; G06Q 30/00; G06Q 40/00; G06F 3/048; G06F 17/00; G06F 15/16; G06F 11/07; G06F 3/01

(52) U.S. Cl. 705/35; 715/843; 715/205; 709/203; 714/48; 715/753; 714/E11.025

(57) ABSTRACT

A proprietary software program written in My SQL and PHP derived originally from a precedent functional model built/programmed in Microsoft Excel's underlying Visual Basic Application (VBA) program. Also an interactive multimedia format and online secure web server platform built to embed the software program in virtual space. This combined software programming and internet-based technology allows for the new proprietary features such as the hyperlinked navigation, streaming video presentation component, self-populating and linked formula text and numerical data fields, multiple choice drop down menus, multi-preparer collaboration from remote separate locations, licensable access, automatic preparation of sophisticated analysis reports, check boxes that trigger colored markers, compliance alert color alarms tied to responses, online deal flow networking and report presentation sharing, and other features not possible with existing available business plan reports or software.

The Funding Roadmap is the title of the invention being presented for the issuance of a utility patent. The invention is a virtual space (cloud computing) software-based solution presented as the first standardized business plan and due diligence reporting system delivered in a multimedia format hosted on an online server-based preparation and presentation platform created, invented, developed and trademarked by its co-inventors as the Funding Roadmap. The Funding Roadmap is a novel and innovative development that renders the traditional paper model business plan report as well as its computer generated software template model obsolete as it has recently been evolved to the next stage of being built for use “in the clouds” (virtual space) with many new content, structural and format changes where it is now much more than just a business plan. It is a completely new non-static, smart, interactive and network-enabled multimedia system of standardized reporting made for the presentation of entrepreneurial business ideas and the associated pertinent business information of interest to critical reviewers with the interest of performing due diligence and deal or business opportunity evaluations.

### CROSS REFERENCE TO RELATED APPLICATIONS

There are no cross references to related applications in this current application.

### STATEMENT OF FEDERALLY SPONSORED RESEARCH/DEVELOPMENT

There is no statement of federally sponsored research/development in this current application.

### REFERENCE TO COMPUTER PROGRAM LISTING APPENDIX SUBMITTED ON COMPACT DISC (CD) AND INCORPORATION BY REFERENCE OF MATERIAL ON CD

This section shall be taken as a Reference to two (2) computer program listing appendices submitted respectively on two (2) separate compact discs. The content of these discs describe and illustrate compositional elements of the design, content, layout and functional utility of the software-solution portion of the invention in its original and complete form which has evolved through two (2) phases of development in its status of programming and utility. The two (2) compact discs containing a full layout of these First and Second phases of development are respectively entitled “Funding

Roadmap in Microsoft Excel” (on Disc No. 1) and “Funding Roadmap in PHP, My SQL and Ajax” (on Disc No. 2).

Whereas the computer program on Disc No. 1 reflecting the First (#1) phase of the software was developed in Microsoft Excel and its respective underlying program known as Visual Basic Application (VBA), or popularly “Visual Basic”, and thereby reflects the state of the software's development before its conversion into a proprietary software language program. Included in this Microsoft Excel program are two (2) editions of the invented software where the distinguishing differences are the content layout. One version is entitled the “Debt Capital Edition” and the second version is entitled the “Equity Capital Edition”.

Whereas the computer program on Disc No. 2 reflecting the Second (#2) phase of the software was developed in PHP, My SQL and Ajax, giving it a proprietary software language status and thereby reflects the latest state of design, layout and functional utility after its conversion on Jan. 1, 2009.

### BACKGROUND OF THE INVENTION

In small business funding there are two sides of the equation for getting a loan or investment funded. On the demand side of the money for business funding is the proponent that needs the funding called the Presenter, and on the supply side of the money for the business funding is the proponent that has the funds to lend or invest called the Reviewer. The genesis of the Funding Roadmap in its current state of development started off as coupling of two formerly static documents used in the presentation and evaluations made for small business funding.

These first of these two presentational documents are known as a Business Plan and the second of these two documents are known as a Due Diligence Report. A business plan is normally prepared by the Presenter who needs a suitable presentation of their business opportunity to deliver to funding sources who will use the business plan as a principal tool to aid them in evaluating the merits of the deal being considered as a lending or investment opportunity. Business plans are also used a guidelines and benchmarking tools for management to help navigate the continued development of their growing business concern.

The due diligence report portion in such a case offers a secure centralized and accessible file in which to quickly index, find and update critical business information of interest to management and shareholders having nothing necessarily to do with the future plans for the business.

Insofar about usage for funding presentations however, once it is decided that the deal has enough merits to be further considered the Reviewer will decide to conduct a deeper evaluation of the opportunity. This deeper evaluation procedure or process is known in the business funding industry as Due Diligence. A business plan by itself does not normally contain very much due diligence information because it is ideally a selling document with a focus on future prospects which is projective in nature, versus a document designed to present hard historic and current factual accounts of business.

The report to document the investigative evaluation that does focus on hard facts of the past and current day is known as a Due Diligence Report which is never prepared by the Presenter but always by the Reviewer to use as a tool to checklist their evaluation results from which to make a final decision about lending or investing. Thus a due diligence report is normally prepared by and exclusively for the use and benefit of the professional lenders and investors (such as banks, venture capital firms and private and institutional funding sources) who must evaluate the presentations of companies they choose to investigate as possible investment or lending opportunities.

The process of evolving from the stage of receiving and reviewing business plans to the latter stage of screening out opportunities by conducting due diligence is laden with many cumbersome and inefficient liabilities, risks, opportunity losses and prohibitive cost factors that consume an inordinate amount of time and money that often burdens the entire process with unpleasant surprises and other undesirable outcomes that have plagued the small business funding industry for many decades. The result of this has been participatory discouragement among players on both sides of the small business funding equation to where more and more of their objectives and goals are not getting accomplished. In addition Presenters and Reviewers speak different “languages” (lingo) and have different and conflictive “concerns and objectives” that are often mismatched where most

Presenters are already naturally challenged with the dreaded task of preparing business plans while most Reviewers are challenged with the task of only being to able to review a limited volume of business plans within given and very often constrictive time constraints.

The end result of these inefficiencies is that small businesses have needlessly restrictive access to capital and small business funders have needlessly restrictive access to enough quality deals or do not have systems that allow them to expedite the due diligence process without compromising the quality of the due diligence results to select winning deals. Access to capital for small business has remained an unequaled and disproportionately imbalanced playing field largely as a result of such unresolved issues.

The traditional business plan model, even the software generated business plan preparation programs that produce static printed reports, are outmoded in this modern day and age governed by the high demand and overdue need for virtual existence and speed-of-light expediency in processing high volumes and multiple categories of complex data and information. In this day of repetitive episodes of economic uncertainty, hyperinflation, marketplace crashes, unstable marketplaces, restrictive capital and faulty due diligence procedure requiring a revival of rules on full disclosure and accountability, the demand for a system to automate and streamline due diligence and secure records in a secure virtual storage area is on a global scale with very high levels of international scope and appeal. Finally as a socially conscious concern our online paperless product has the distinction of leaving no carbon footprint behind due a trail of printed reports, software packaging, shipping, warehousing, etc.

Our invention, the Funding Roadmap, provides an answer to this multi-layered series of unaddressed and unabated industry-wide and age-old dilemmas. Our first approach to an answer was to combine the business plan and due diligence report into one cohesive reporting system prepared entirely by the Presenter giving them an opportunity to answer due diligence questions before they get asked later when it is usually too late to prepare or compensate for the wrong answers and correct being in a state of ill-preparedness by making appropriate changes from what is discovered to be out of compliance with lender/investor standards from examination the due diligence reports. Out next approach was to change the static nature of these finished reports into a live electronic business documentation and reporting system presented in an interactive multimedia format that offers benefits for its users that are not at all possible with the traditional static and paper-based business plans generated from computer software template programs. This is where it became possible to engage all of the quick, easy and convenient preparatory and navigational tools that have become invaluable features of the software itself.

Then for ultimate security and utility we have decided host and make this entire system accessible to Presenters and Reviewers on a highly secure online server network (“in the clouds”) or in a computing environment that we have come to know as “virtual space”. Our next approach was to make this system accessible to distributors and end-users by offering it as a licensable subscription that can be hosted on our own secure server or transferred to the secure server of master license holders.

It is our intention for this invention to compensate for the shortfalls and inefficiencies of, and eventually replace and supersede the use of traditional paper, template-based and printed business plan used by preparers to make presentations to reviewers for the purpose of submitting important and valuable information about their companies or business deals that such reviewers need to know before making decisions to entertain their submitted financing or other business opportunity.

The old business plan report in its current state has been in prevalent use for over 40 years and its value to reviewers has sharply declined as its efficacy has continued on unproven. Preparers making the presentations of the report consist of small business owners, entrepreneurs, business promoters, etc. while the Reviewers evaluating the presentations of the report consist of sources of financing such as banks, venture capitalists, angels networks and other potential lenders, investors and financiers, and business opportunity prospects who may have a need for conducting due diligence or similar evaluations of prospects before making such decisions to entertain such funding or other business dealings.

### BRIEF SUMMARY OF THE INVENTION

The Funding Roadmap is an online server-based standardized business plan and due diligence reporting system that contains a host of novel features for preparers/subjects and reviewers/evaluators of the resulting report. It is billed as the first business plan combined with a due diligence report and built in the “clouds” (virtual space). There are principal feature advantages that lend to its novelty or newness. These principal feature advantages for the Preparer/Presenter is that:

It offers a questionnaire layout formatted largely into multiple-choice drop down answer menus populated with the only possible right answers and educational notations that aid the preparer in completing the right responses in both narrative and drop down menu sections. Multiple sophisticated reports are automatically generated from the answers given in sections where financial or quantitative data must be presented, compliance alarms alert the prepare when their answers are out of bounds. The preparer can have authorized co-preparers collaborate on the preparation from anywhere in the world. The report can be quickly indexed, navigated, and searched from anywhere in the world by any reviewer party granted authorized access. The report is comprehensive and very thorough while at the same time concise and condensible. The navigational tools and hyperlinks between the table of contents and the body of the report make it fast and easy for the Reviewer to index, scan, navigate, read, study, check off and organize review notes.

All bases of consideration have been covered and dealt with, due diligence investigations and verifications can be streamlined to ultimate expediency and funding decisions can therefore be made much more quickly, the report can be exhibited to any funding source or sources or networks desired by the Presenter. All of this is done in a multimedia sharing and highly secure virtual space computing environment (“in the clouds”).

### BRIEF DESCRIPTION OF THE SEVERAL VIEWS OF DRAWING

The drawings (consuming a total of 19 pages) consist of screen shots of the initial pages of each of the five (5) tabs on the web page of the software itself upon user log in. The 5 tabs are labeled the Cover Page, Executive Summary, Business Plan, Due Diligence Report and Numerical Summaries.

Specifically FIG. 1 on Page 1 is a photostatic copy of the website page entitled as the Cover Page (Tab #1) of the FRM Software. This is the face of the page for the beginning of the presentation of the reporting company.

FIG. 2(A) through 2(B) on Pages 2 through 3 is a photostatic copy of the website page entitled as the Executive Summary (Tab #2) of the FRM Software where FIG. 2(A) exhibits the top half of the page while FIG. 2(B) exhibits the bottom half of the page. This is the subsection of the business plan component where the entire business presentation is summarized as a narrative report. On the top half of this page shown in FIG. 2(A) in particular is the section where the presenter can upload a streaming video to present their videotaped elevator pitch or other presentation that calls for the use of audio/video media.

FIG. 3(A) through 3(G) on Pages 4 through 10 is a photostatic copy of the website page entitled as the Business Plan (Tab #3) of the FRM Software where each of these pages exhibits a vertical linear arrangement of the Table of Contents for the Business Plan section where the topics and subtopics are hyperlinked in both directions (to and from each other) to the body of the report in each of their respective categories of content labels.

FIG. 4(A) through 4(F) on Pages 11 through 16 is a photostatic copy of the website page entitled as the Due Diligence Report (Tab #4) of the FRM Software where each of these pages exhibits a vertical linear arrangement of the Table of Contents for the Business Plan section where the topics and subtopics are hyperlinked in both directions (to and from each other) to the body of the report in each of their respective categories of content labels.

FIG. 5(A) through 5(C) on Pages 17 through 19 is a photostatic copy of the website page entitled as the Numerical Summaries (Tab #5) of the FRM Software where each of these pages exhibits a vertical linear arrangement of the Table of Contents for the Business Plan section where the topics and subtopics are hyperlinked in both directions (to and from each other) to the body of the report in each of their respective categories of content labels.

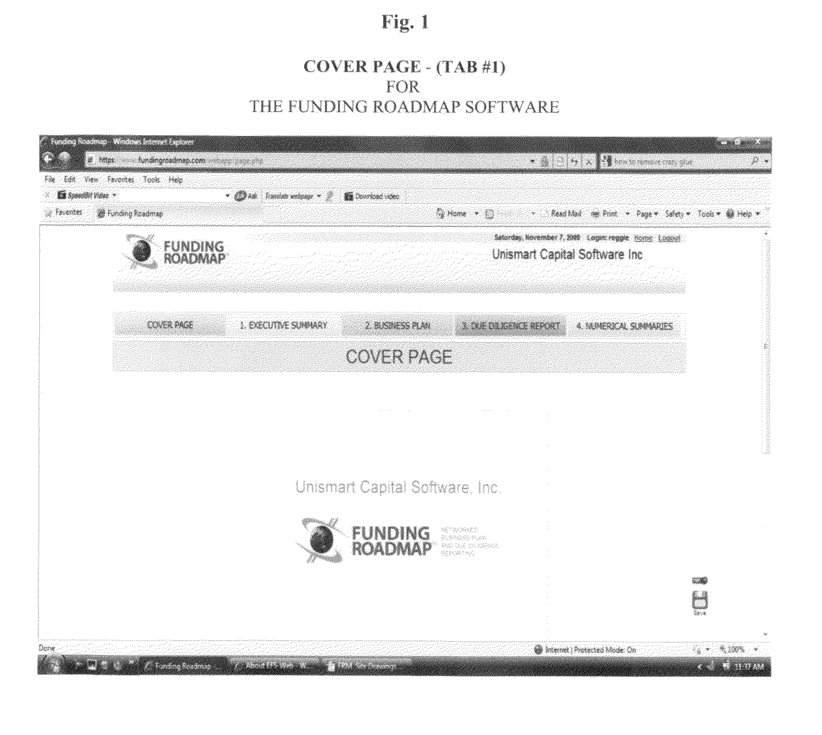

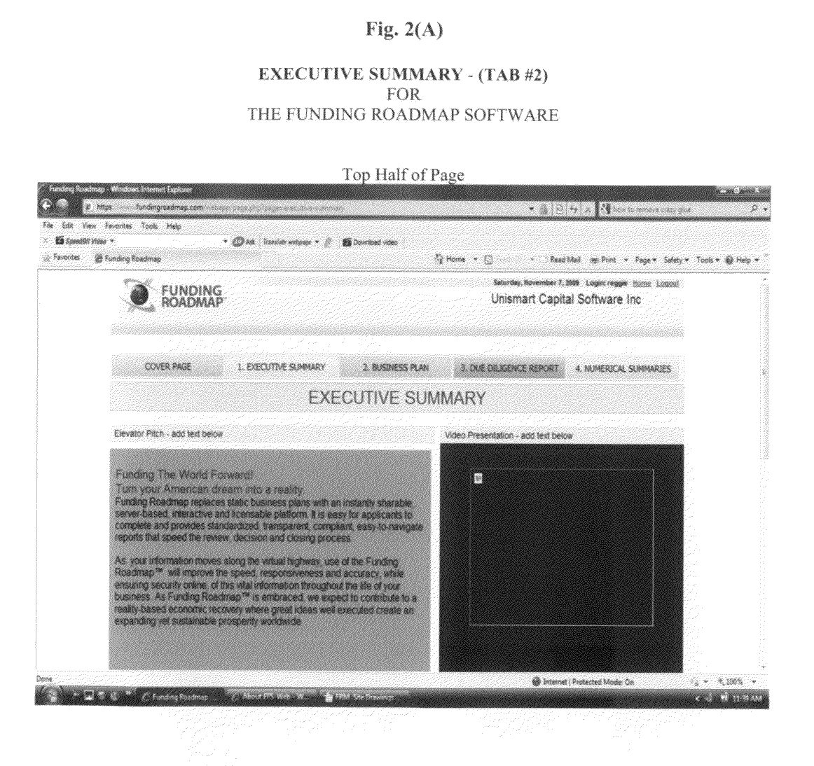

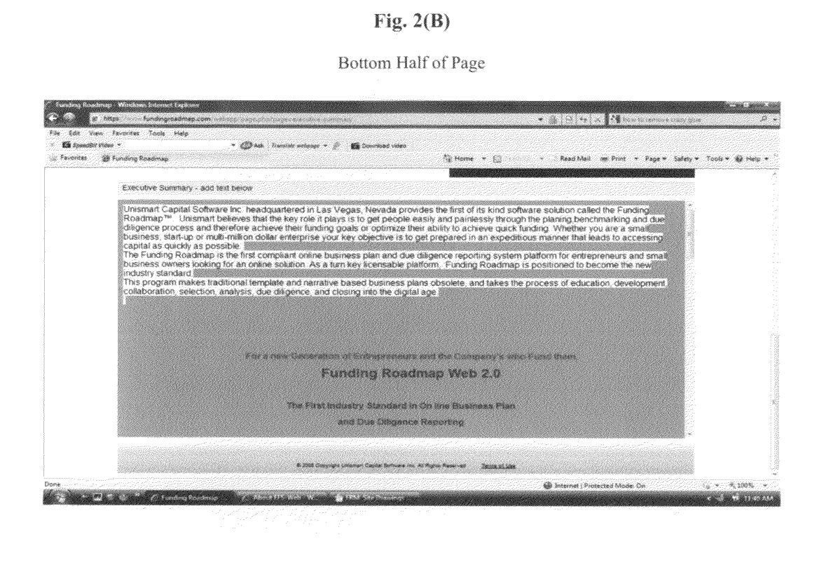

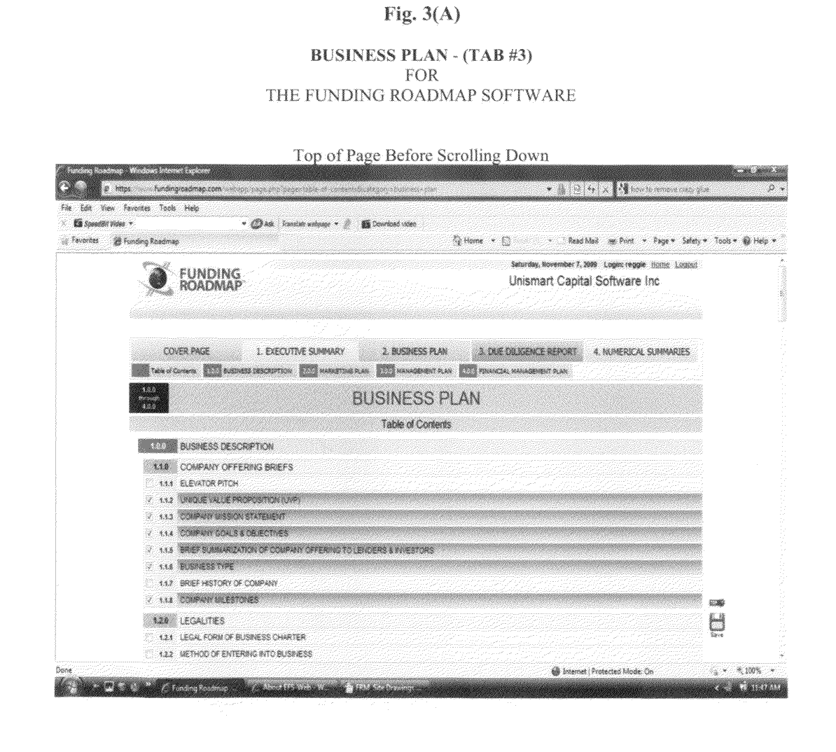

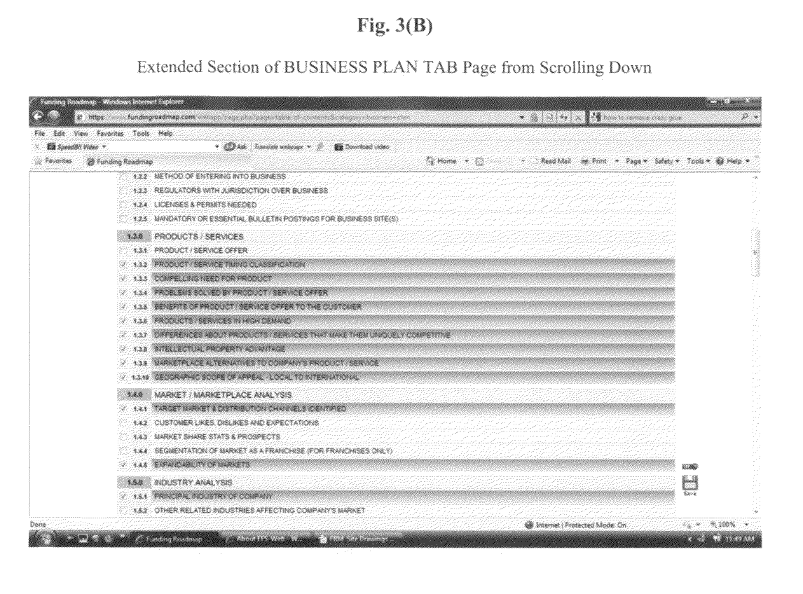

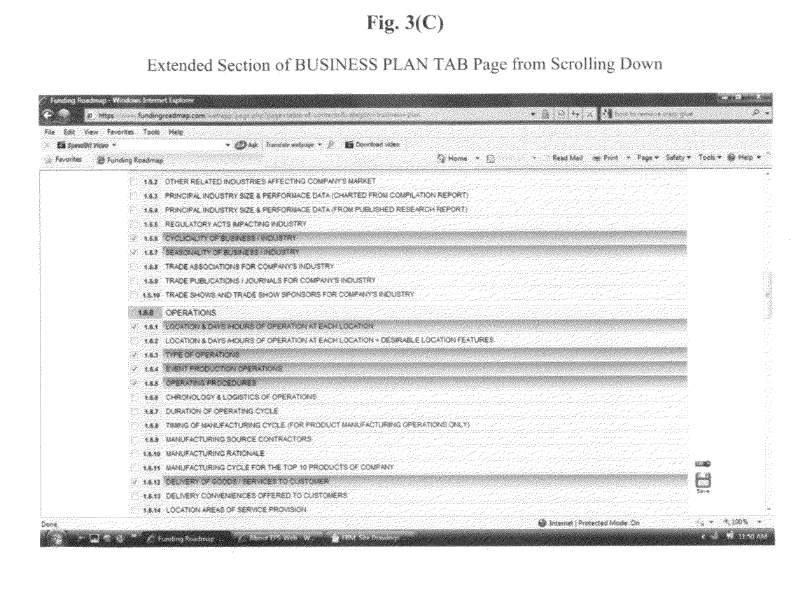

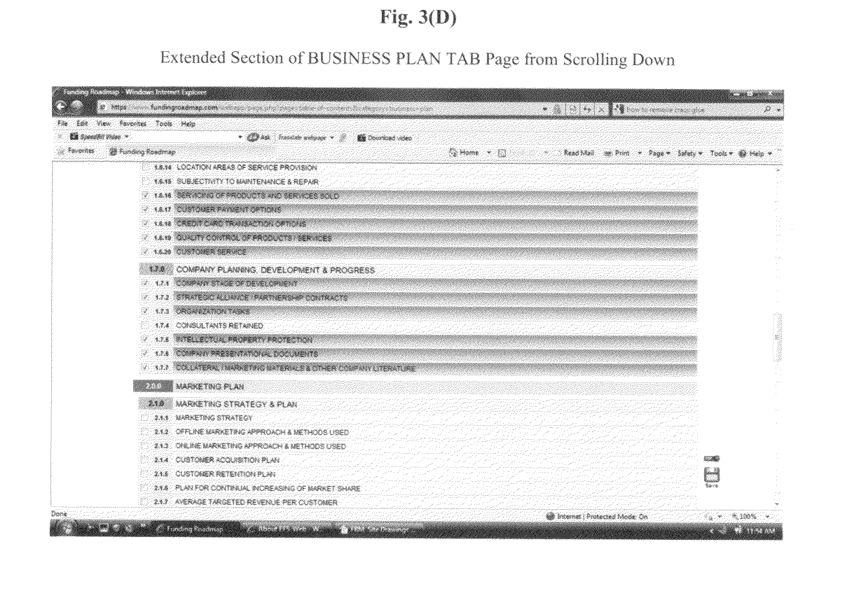

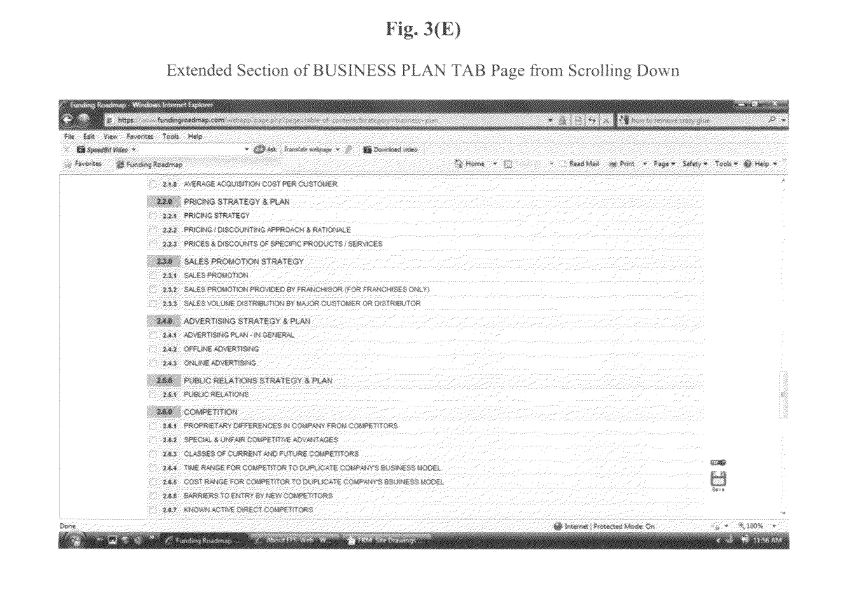

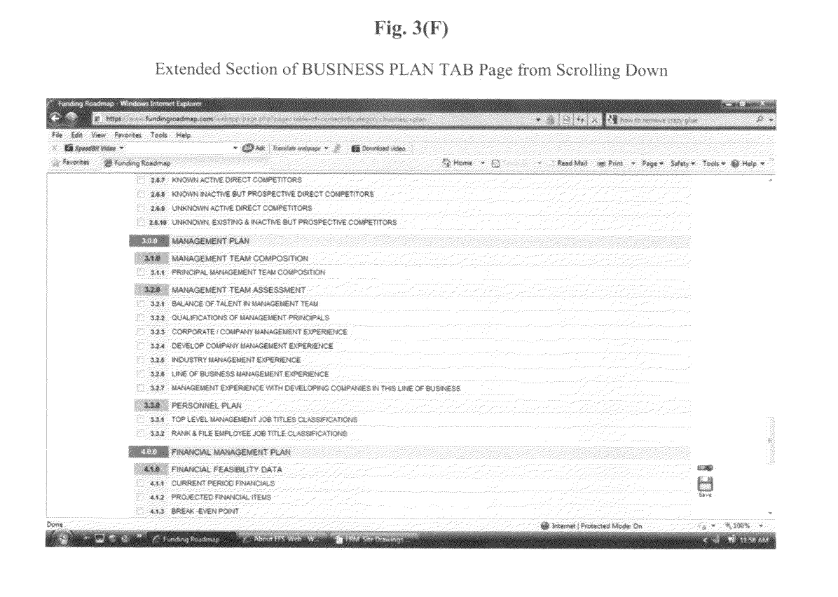

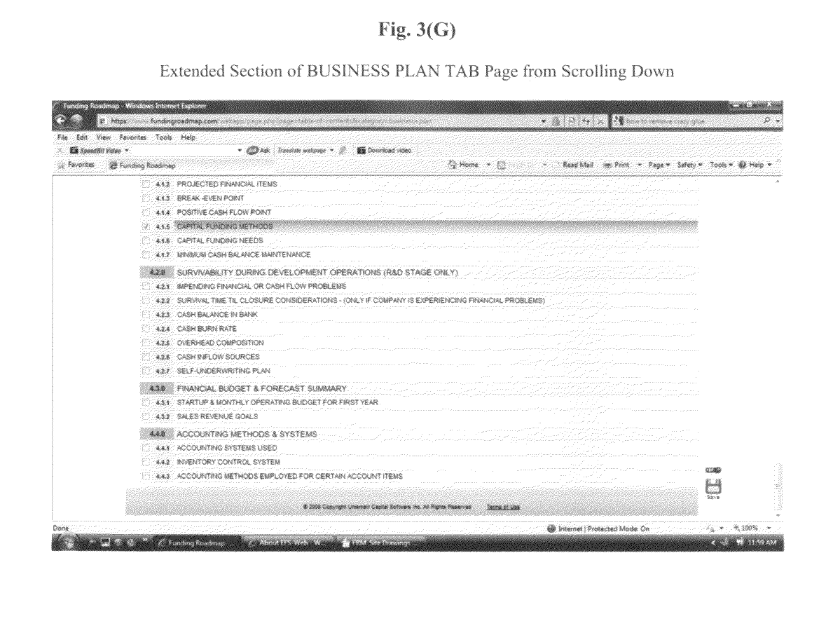

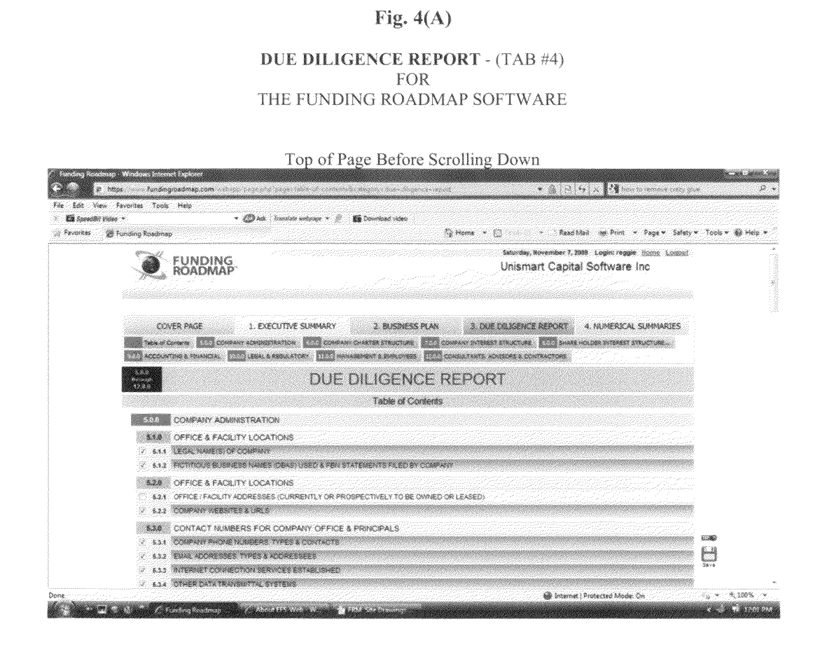

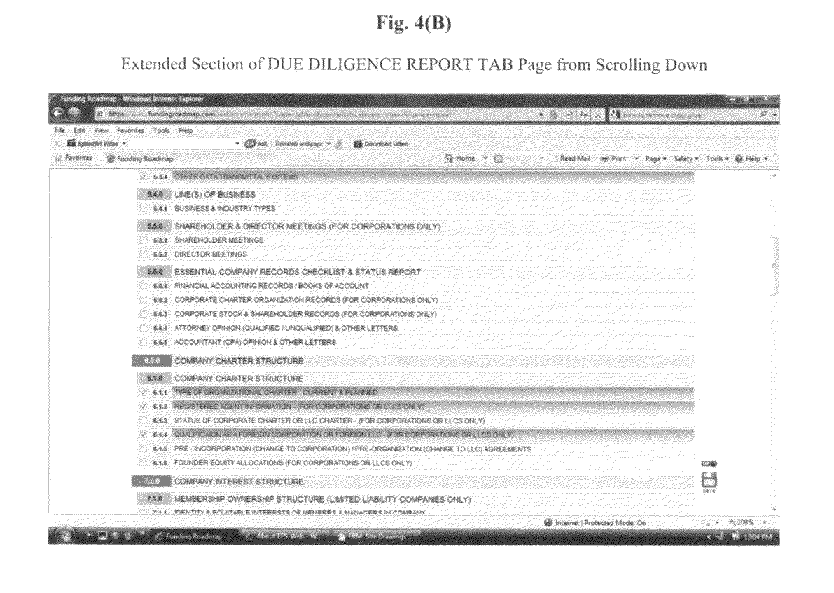

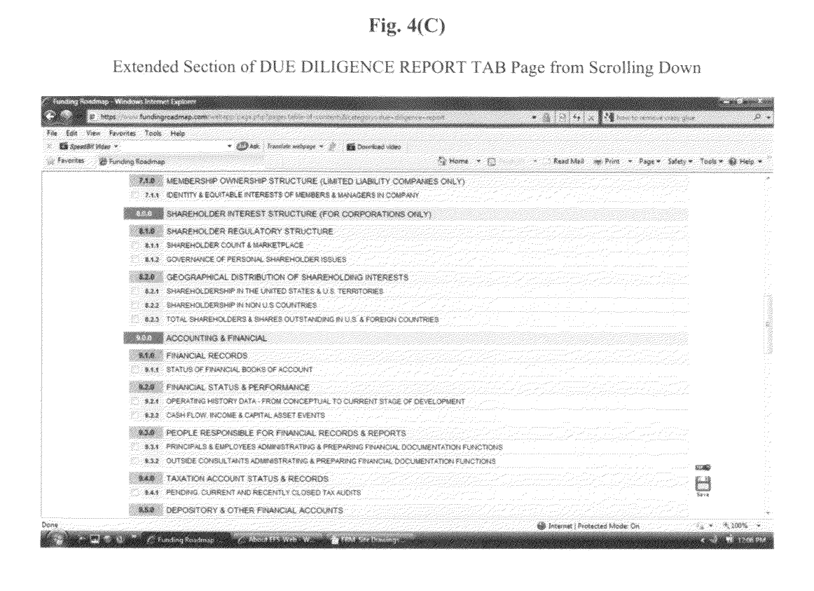

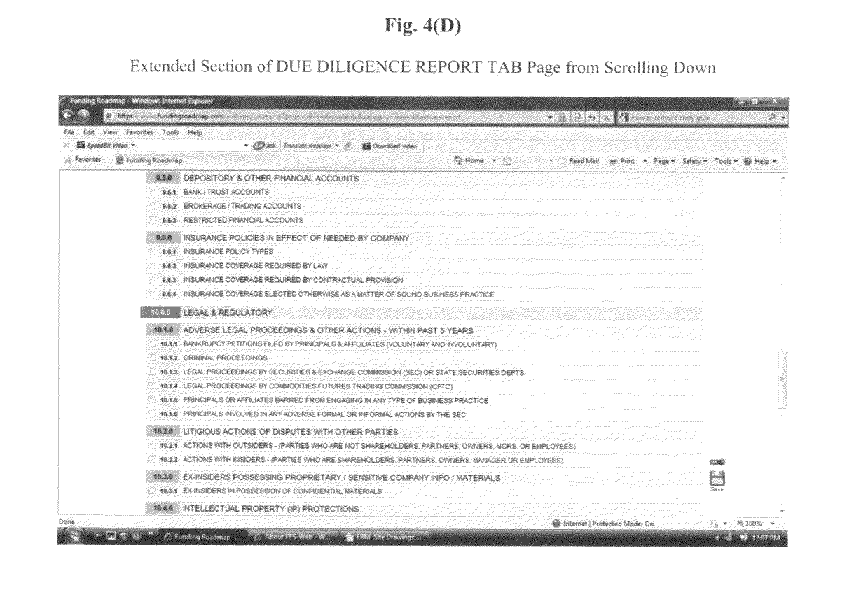

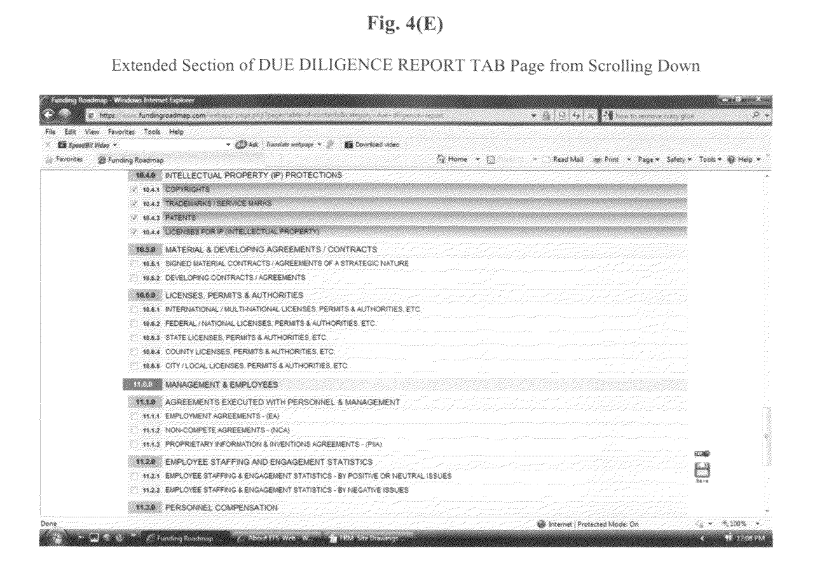

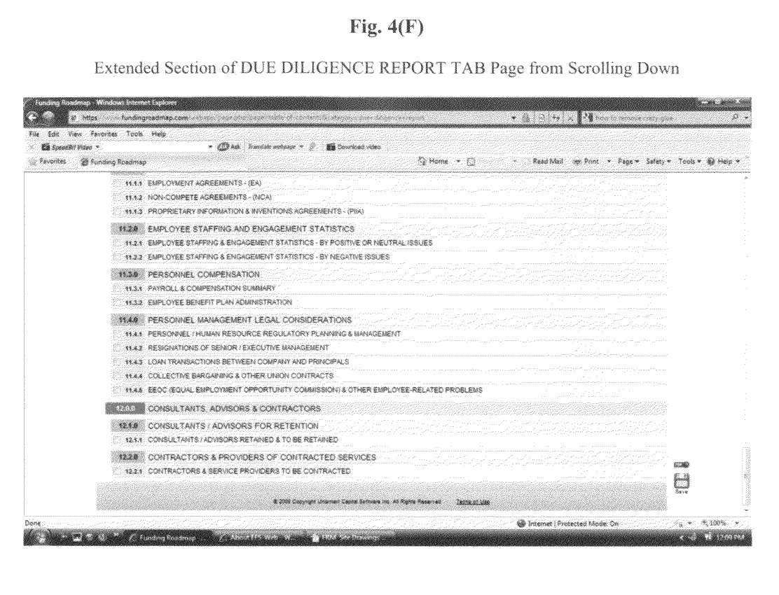

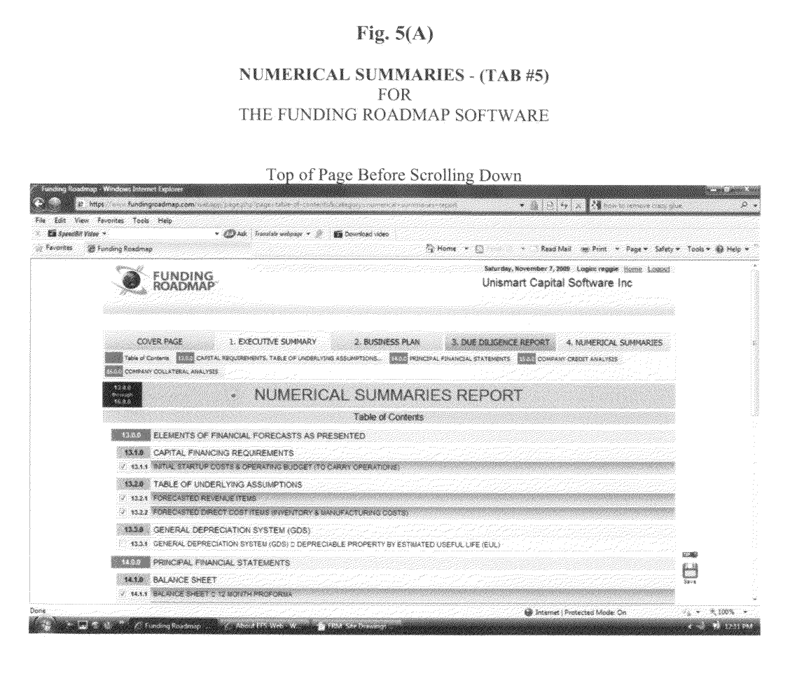

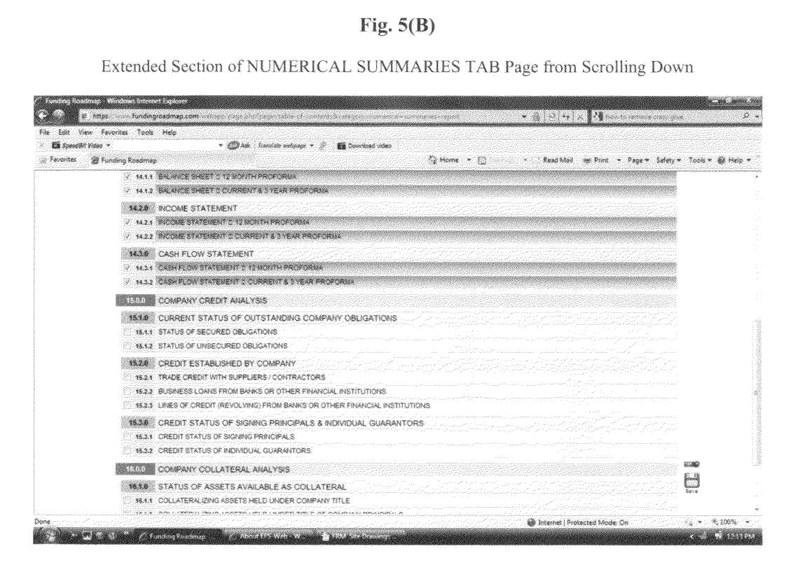

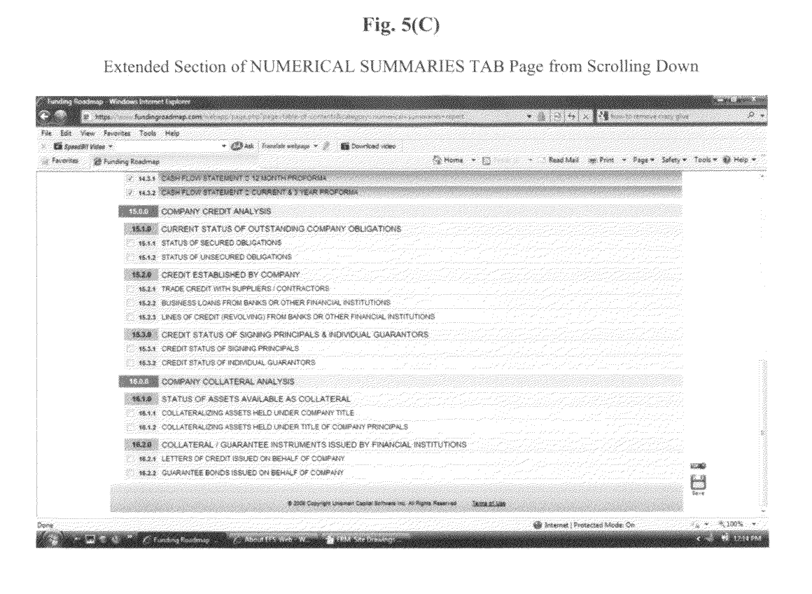

### DETAILED DESCRIPTION OF THE INVENTION

The Funding Roadmap is an online-based software solution designed specifically as a standardized business plan and due diligence reporting system in electronic format composed of the following layout scheme. It is organized and divided into 5 Tabs, one of which includes a Cover Sheet, the other 4 of which makes up the Principal Reports entitled the Executive Summary, Business Plan, Due Diligence Report and Numerical Summaries. Each of the tabular reports contains a Table of Contents arranged by topic name and preceded by a standardized numerical index of its location. The Executive Summary includes space for a Written Elevator Pitch and a designated section for an uploaded Video Elevator Pitch. The Business Plan includes business plan subtopics and queries, the Due Diligence Report includes due diligence report subtopics and queries, and the Numerical Summaries includes Financial Reports including the Principal Financial Statements (Current and Pro Forma), Table of Underlying Assumptions to the Pro Forma Statements, Capital Requirements, and the Credit & Collateral Analysis Tables.

In each Topic, Subtopic and Query there is a Color Code shaded in the horizontal bar perimeter of each Named Section of each report where Light Blue shading indicates a Topic, Light Green shading indicates a Subtopic and Yellow shading indicates a Query.

The Table of Contents has Checkboxes next to each subtopic that activate a color alarm when checked. These check boxes are used by the preparer to keep up with their progress toward completion, and subsequently they are for use by the reviewer to keep up with sections they wish to review in some order of priority and eliminate sections as they make the reviews.

Hyperlinks are embedded in the Table of Contents line linking them to the relevant section in the body of the report for quick point-and-click navigation to that respective section, and the same quick hyperlinking navigation can be accomplished moving from the body of the report back to the same place in the Table of Contents. Navigation can also be accomplished by Vertical Scrolling up or down the page to the desired section.

The finished report is created by the responses to a questionnaire-style layout that is completed partially by freehand narrative responses and largely by selecting from multiple-choice drop down menus to compose a full report. Yes and no answers are also selected from a multiple choice menu as well as most quantitative data requiring a numerical entry. In the financial statements and other Numerical Summary entries, entire numbers must be typed in. In such cases calculation fields will self-populate when the independent fields are filled with linked data that compose the formula it is dependent upon. Text data is also self-populated where it is linked to prevent redundancy of entered data through other sections of the report where the duplicate information is needed for a query.

If more answering fields are needed the user has tool options to expand (and contract) or select more answer fields to fill in additional answers, whether for narrative responses or for multiple choice menu responses.

With the exception of vertical scrolling and self-populated linked calculation fields for numerical data entry that can be seen in premium business plan software, these descriptive characteristics as indicated above are completely NEW in our software invention, impossible in paper-based or printed business plans, and still non-existent in any existing business plan preparation software including the world's top and best selling brands. They all produce the same end product with the same limited functionality, a static printed business plan designed for presentation in the finally produced static printed format that must be read at a much slower pace like a book and does not address any appreciable degree of due diligence concerns that is satisfactory to any lender or investor or other party interested in ascertaining relevant hard facts.

To delineate the acute differences between our invention and existing products of a presumed competing stance to what part of our product serves as a superseding replacement, (that is the traditional, most familiar and outmoded business plan), The Funding Roadmap differs from the traditional business plan in the following ways that makes it truly novel in its utility, design and content:

Standardization: the report is standardized with a topic-subtopic categorization and numerical indexing system that allows the reviewers to find the same answers to the same questions in the same place on any such report each and every time.

Multiple Choice Menu: a large portion of the questionnaire format is populated with drop down menus pre-populated with multiple-choice answers that represent the only right or compliant responses to the given query.

Video Elevator Pitch: a streaming video presentation allows presenters to upload a recorded video/audio elevator pitch or other message to lenders/investors/reviewers.

Virtual Space Cloud Computing: the software is built in the “clouds” (virtual space) onto a highly secure server online eliminating the need for users to download software applications onto any hard drive and offers complete security and confidentiality of the data making such records immune to the effects of damage from computer crashes, software virus, fires, water damage or natural disaster events.

Multi-Preparer Collaboration: This feature also enables the presenter to collaborate with other co-preparers such as officers, directors, advisors, attorneys, accountants, etc. anywhere in the world

Deal Flow Networking: This feature allows the presenter to share their report and presentation or designated sections of it online to controlled groups or authorized reviewers and connect such presenters with their target audience of lenders, investors or potential venture partners anywhere in the world.

Licensable Access: This feature also allows the Funding Roadmap to be issued as a licensable subscription that can be either hosted on/from our web site or completely moved onto another server of a master license holder for redistribution to an end-user licensee.

Sophisticated Reports & Analysis: This feature produces sophisticated reports that the reviewer would normally prepare themselves from extrapolating certain data from the business plan and due diligence data collected independently. This eliminates their need to transpose data onto other report and analysis systems to further analyze when they can do so immediately on our report.

Compliance Alarms: When certain sections of the report are filled in with incorrect or non-compliant information a color-coded compliance alarm will indicate such error and request a correction.

The Funding Roadmap is still under ongoing research & development for upgrades and improved features. Scheduled for upgrading are the following technological integration developments:

Apps: To make this new feature of enhancement possible we have decided that we will integrate a new sweeping technology known as “apps”. Apps is an abbreviated reference for applications and refers to the mini applications tied into the tools used on cell phones and other portable multimedia devices that operate with many of the same functions as cell phones that are also used as computers in communications and data management. The purpose for our App will be to enable the user to access their Funding Roadmap info on the fly from any location where they are inaccessible to a computer with internet access such as while commuting in traffic or at a restaurant while having a meeting with an investor or other prospect in reference to their Funding Roadmap report. They will need instant access to specific and accurate data on their reports and this App feature will allow them to instantly pull it up on their cell phone device. On an app feature on the phone this can practically be done in basically one or two ways. They can either go to the app page and type what they are looking for in a “Search Field” to narrow down their target line item down to a specific selection, or they will have the option to scroll a pre-populated index of line items arranged by alphabetization or by topic-subtopic (or say maybe the top 50 most commonly referred to line item points that a presenter would want or need to refer to on the fly in a conversation about their company) and pull up their resulting item of information needed to present or talk about to their prospect. The three (3) most prevalent providers of cell phone apps (and other similarly functioning portable multimedia communications/data management devices that access the internet) are I-Phone, Blackberry and Google/T-Mobile via an app known as Android. In our judgment it will best suit us to develop an app utility designed for integration with these top three provider brands at a minimum.

Echosign: In addition, we also plan to integrate an “E-Signature' utility function within the Deal Flow features of the Funding Roadmap. This application will allow for the electronic signature of any documentation between prospects dealing among each other but are especially useful for documents that are anticipated to be used during the reviewing and negotiating process such as non-disclosure/confidentiality, non-circumvent, agreements, letters of intent, memorandum of understanding, consulting/agency representation agreements, etc. To implement this technology we have decided to partner with our existing technology partner, Echosign. This technology eliminates the hassles and extra-time consumption involved in using the regular mail or facsimile to obtain multiple signatures on documents that require signatures that are meant to be legally binding between two or more parties. The documents themselves are incorporated in the transfer (by email) ready for multiple electronic signatures during transit and the finished signed documents can be printed out by everyone involved but for extra security are kept on on a secure server for access at any time in the future.

Virtual Roadshow: this feature will enable us to host online a server-based televideoconferencing facility that will allow our Funding Roadmap subscribers to put on a Live Video Roadshow to investors located anywhere in the world from anywhere in the world.

Webex: This feature is a technological integration to help users of the invention communicate as if they are “face-to-face” with other people across world and present to or share their Funding Roadmap presentation with anyone with a computer and Internet access. The communicating parties look at each other in a screen as the presenter walks them through whatever they need to see to get the visual and audio impact of the presentation. The Webex technology allows the presenter to control the images displayed on the screen. Its a complete virtual presentational tool. Presenters can also use this feature to collaborate with an entire team of participants from anywhere in the world.

Cisco Video Stream: This Webex feature will be enhanced by and integrated with the Cisco Video Stream and/or other live video technology allowing Funding Roadmap subscribers to log into one website and start a live video conference road show and enjoy the advantage of having all of these complimentary technologies embedded for access in their Funding Roadmap report presentation experience.

1. The following summary serves as a general description of all the elements of the claimed combination which are conventional or known:
The elements of our claimed combination which are conventional or known consist of a business plan preparation software program that can be filled out using data entry fields on a computer, converted to a portable document file (pdf) format and printed out for review. It can also be navigated on computer by selecting tabs for appropriate sections and scrolling down or up to navigate the connected pages. The financial statements include independent data entry fields that are linked to formula dependent fields to calculate formulated data to complete the financial statements. The report includes typical business plan categories in some logical topical order of presentation from a table of contents page. The data entry spaces designed for narrative responses are expandable or contractible to accommodate the length of the total data entered. This is where the similarities to traditional business plan preparation software end.
Our invention is an improvement upon the traditional modern day business plan preparation software and is also a novel development of a new type of comprehensive reporting system that offers features, accomplishes goals, achieves objectives and renders benefits not available or even made possible through use of traditional modern day business plan preparation software. This Independent claim hereby represents that we have invented the Funding Roadmap, which is an invention we consider to be the worlds first questionnaire-style formatted business plan software combined with a due diligence report which makes a complete integrated report and comprehensive reporting system we have designed and engineered to be both prepared, submitted, presented and reviewed in electronic format, and done so online in virtual space—meaning by remote internet server access—versus in physical printout format from a software program download as is typical of modern day business plan preparation software. Software presented with to design of this type systemic technological feature is known as being built “in the clouds”, where the term “clouds” is derived from internet technology lingo used to describe a remote access condition and concept better known as “virtual space” or the provision of software features and functions that have an online web-based server presence and utility without the necessity of having to downloaded an actual software application program to a physical computer hard drive to elicit these functions and realized these featured benefits.
What follows are those elements, steps, and/or relationships which constitute the portion of the claimed combination which the as the applicants consider as the new or improved portion of our invention. It is our electronic format and online web server accessibility that allows for the existence and use of the following new and advantageous features by both preparers and reviewers of the integrated report:
Standardization: the report is standardized with a topic-subtopic categorization and numerical indexing system that allows the reviewers to find the same answers to the same questions in the same place on any such report each and every time.
Multiple Choice Menu: a large portion of the questionnaire format is populated with drop down menus pre-populated with multiple-choice answers that represent the only right or compliant responses to the given query. This is in contrast to only spaces allowed to contain written narrative responses as provided by typical business plan software.
Self Populating Data Fields: The designed and automated linking of text and numerical information in independent (or “open”) data entry fields that automatically populates itself into linked dependent (or “closed” or “locked”) data fields eliminating the event of time wasting redundant/duplicate data entries. In the case of numerical entries such linking eliminates the need for conducting mathematical calculations that are done automatically to populate financial statements as well as other quantitative data that uses input from independent fields to populate formula dependent fields.
Hyperlinked Navigation: Hyperlinks (“go-to” formula links) are embedded in the Table of Contents line linking them to the relevant section in the body of the report to allow for quick point-and-click navigation to that respective section, and the same quick hyperlinking navigation can be accomplished moving from the body of the report back to the same place in the Table of Contents. This feature allows for speedy navigation through the report as would never be possible in reading a printed out version or even scrolling down a computer screen to read such a report.
Streaming Video Presentation Component: this feature allows for the uploading and presentation of an “elevator pitch” or other audio/video presentational message made by the presenter or reporting company to an audience of lenders/investors/reviewers.
Virtual Space Cloud Computing: the software is built in the “clouds” (virtual space) onto a highly secure server online eliminating the need for users to download software applications onto any hard drive and offers complete security and confidentiality of the data making such records immune to the effects of damage from computer crashes, software virus, fires, water damage or natural disaster events.
Multi-Preparer Collaboration: This feature also enables the presenter to collaborate with other co-preparers such as officers, directors, advisors, attorneys, accountants, etc. anywhere in the world
Deal Flow Networking: This feature allows the presenter to share their report and presentation or designated sections of it online to controlled groups or authorized reviewers and connect such presenters with their target audience of lenders, investors or potential venture partners anywhere in the world.
Licensable Access: This feature also allows the Funding Roadmap to be issued as a licensable subscription that can be either hosted on/from our web site or completely moved onto another server of a master license holder for redistribution to an end-user licensee.
Sophisticated Reports & Analysis: This feature includes the automatic production of sophisticated analysis reports and sub-reports created from results of entered questionnaire data for the reviewer to use on the report itself instead of extrapolating certain raw data from the report onto other forms, systems or programs to conduct such varied analyses. This feature produces sophisticated reports that the reviewer would normally prepare themselves transposing selected data from the business plan plus due diligence data collected independently.
Compliance Alarms: When certain sections of the report are filled in with incorrect or non-compliant information a color-coded compliance alarm will indicate such error and request a correction.
Checkboxes: The Table of Contents has Checkboxes next to each subtopic that activate a color alarm when checked. These check boxes are used by the preparer to keep up with their progress toward completion, and subsequently they are for use by the reviewer as markers to keep up with sections they wish to review in some order of priority and eliminate sections as they make the reviews.
